(19) United States
(12) Patent Application Publication
(10) Pub. No.: US 2021/0115964 A1
(43) Pub. Date: Apr. 22, 2021

(54) WASHER

(71) Applicant: Toshifumi YAMASHITA, Kagoshima (JP)

(72) Inventors: Toshifumi YAMASHITA, Kagoshima (JP); Masakazu MAEHARA, Kagoshima (JP)

(21) Appl. No.: 17/043,968

(22) PCT Filed: Apr. 7, 2019
(86) PCT No.: PCT/JP2019/015235

§ 371 Date: Sep. 30, 2020

(30) Foreign Application Priority Data
Apr. 8, 2018 (JP) 2018-074340

(51) Int. Cl. F16B 43/02; F16B 39/24

(52) U.S. Cl. CPC F16B 43/02; F16B 39/24

(57) ABSTRACT

Provided is a washer which aims at the realization of prevention of loosening of a screw at a high level by enhancing a frictional force between a male screw and a female screw hole or a nut while maintaining advantageous effects of a plain washer and a spring washer with a simple structure.

The washer 1 according to the present invention includes a body portion 1a having a dome shape in an external appearance. A screw insertion hole 2 is formed in the body portion 1a. The body portion 1a is formed of a spring member which is deformable into an approximately flat plate shape by a pressing force in a vertical direction, and is inclined toward one side when the washer 1 is deformed into a plate shape.

### BACKGROUND OF THE INVENTION

### Field of the Invention

The present invention relates to a washer which prevents the occurrence of loosening due to a use environment, a use state or the like of a fastened screw.

### Description of the Related Art

Conventionally, a washer is used for preventing loosening of a screw in fastening the screw. For example, in case of a plain washer, when an object to be fastened is fastened only by a screw, a face pressure attributed to an area of a seat surface of the screw concentrates on a surface of the object to be fastened so that the seat surface of the screw is liable to bite into and sink whereby loosening of the screw is liable to be induced. With the use of a plain washer having a larger area than a seat surface of a screw, a face pressure which an object to be fastened receives is dispersed and hence, loosening of a screw caused by sinking of the object to be fastened can be prevented to some extent.

A spring washer intends to prevent the rotation of a screw by an elastic force generated in a vertical direction of the spring washer before the fastened screw is loosened and rotated. In other words, the spring washer prevents loosening of the screw by increasing a frictional force between the object to be fastened and the screw.

However, with respect to the above-mentioned two kinds of general washers, in a case where the washer is used in a severe environment such as a case where a change of a temperature or a moisture is outstanding or in a use state where the washer constantly receives vibrations, loosening of a screw inevitably occurs and hence, a periodical inspection becomes indispensable.

Under such circumstances, for example, JP 2014-055637 A (patent literature 1) discloses a technique relating to a plain washer which has inclination in a thickness direction. This technique is provided for enhancing a frictional force between a male screw and a female screw hole or a nut by obliquely displacing a direction of an axial force of a screw due to inclination of the washer by fastening the screw.

For example, JP-U 48-051960 A (patent document 2) discloses a technique relating to a washer where saw-tooth protrusions are formed on a portion of a lower bottom surface of the washer formed in a dome shape. In this technique, the washer possesses an elastic force in a vertical direction by having a dome shape, plays a role of an anchor to a portion to be fastened by the saw-tooth protrusions, and the elastic force in the vertical direction can be obliquely displaced by inclining the washer. With such a configuration, the washer intends to enhance a frictional force between a male screw and a female screw hole or a nut.

### SUMMARY OF INVENTION

The plain washer according to patent document 1 is excellent with respect to a point that a frictional force between the fastened male screw and the female screw hole or the nut can be enhanced with a simple structure. However, the plain washer does not possess an elastic force and hence, a frictional force in a vertical direction cannot be generated whereby the plain washer is still insufficient from a view point of preventing loosening of the screw.

The washer according to patent document 2 is more excellent than the plain washer according to patent document 1 with respect to a point that an elastic force is generated by forming the shape of the washer into a dome shape, and the direction of an elastic force can be changed by the saw-tooth protrusions. However, in this technique, the washer maintains a dome-shaped external appearance at the time of fastening a screw and hence, although an elastic force is generated attributed to slight deformation of the washer, an allowable range which can follow loosening of the screw is extremely limited.

Further, a state where the washer maintains a dome shape even when the screw is fastened means that only a circular peripheral portion which forms a lower bottom surface of the washer is brought into contact with a surface of an object to be fastened. Accordingly, a face pressure is not dispersed and hence, sinking or a damage is liable to occur in the object to be fastened due to the high face pressure which the object to be fastened receives. Such a state becomes a cause of loosening of the screw.

Further, the saw-tooth protrusions give a damage on a surface of the object to be fastened. Further, stepped portions are formed between the saw-tooth protrusions and other peripheral portions which form a lower bottom surface of the washer and hence, an area of the washer which is brought into contact with the surface of the object to be fastened is further narrowed. Accordingly, the washer cannot sufficiently exhibit an effect of an elastic force in an oblique direction obtained by inclining the washer.

The present invention has been made in view of the above-mentioned circumstances, and it is an object of the present invention to provide a washer which aims at the realization of prevention of loosening of a screw at a high level by enhancing a frictional force between a male screw and a female screw hole or a nut while maintaining advantageous effects of a plain washer and a spring washer with a simple structure.

To achieve the above-mentioned object, the present invention provides the following configurations.

According to the invention called for in claim 1, there is provided a washer comprising a body portion having a dome shape in an external appearance, wherein a screw insertion hole is formed in the body portion, and the body portion is formed of a spring member which is deformable into an approximately flat plate shape by a pressing force in a vertical direction, and is formed to be inclined toward one side as a whole in a state where the body portion is deformed into a plate shape.

According to the invention called for in claim 2, in the washer described in claim 1, the screw insertion hole is formed to have an inner diameter which is narrowed from an upper side to a lower side in a plate thickness direction, and to have an approximately same inner diameter from the upper side to the lower side in the plate thickness direction in a state where the body portion is deformed into the plate shape.

According to the invention called for in claim 3, in the washer described in claim 1 or claim 2, a circumferential side surface of the body portion is formed approximately vertically from an upper side to a lower side in the plate thickness direction, and is formed so as to expand toward an outside from the upper side to the lower side in the plate thickness direction in a state where the body portion is deformed into a plate shape.

According to the invention called for in claim 4, in the washer described in claim 3, a corner portion of a lower bottom of the circumferential side surface is chamfered over an entire circumference.

According to the invention called for in claim 5, in the washer described in claim 4, an ornament is applied to the circumferential side surface.

According to the invention described in claim 1, the washer includes the body portion having a dome shape in an external appearance, wherein the screw insertion hole is formed in the body portion, and the body portion is formed of the spring member which is deformable into the approximately flat plate shape by a pressing force in a vertical direction, and is formed to be inclined toward one side as a whole in a state where the body portion is deformed into a plate shape. With such a configuration, the washer can exhibit an advantageous effect of a plain washer that sinking of an object to be fastened can be prevented by dispersing a face pressure which the object to be fastened receives and an advantageous effect of a spring washer that a frictional force in a vertical direction of a screw can be increased by fastening the screw thus preventing loosening of the screw can be obtained with a simple structure. Further, a direction of an axial force of the screw can be obliquely displaced. Accordingly, the washer can realize the prevention of loosening of the screw at a high level.

The washer has the simple structure and hence, the washer can be manufactured at a low cost. Further, with the use of the spring member, the washer can easily return from a plate shape to an original dome shape and hence, the washer can be repeatedly used.

According to the invention described in claim 2, the screw insertion hole is formed to have the inner diameter which is narrowed from the upper side to the lower side in the plate thickness direction, and to have the approximately same inner diameter from the upper side to the lower side in the plate thickness direction in a state where the body portion is deformed into the plate shape. With such a configuration, in inserting the male screw toward the screw insertion hole from above the body portion, the narrowed inner diameter guides the male screw and hence, an insertion operation can be easily performed. Particularly, when a large number of screws are to be fastened, operability can be largely enhanced.

According to the invention described in claim 3, the circumferential side surface of the body portion is formed approximately vertically from the upper side to the lower side in a plate thickness direction, and is formed so as to extend toward an outside from the upper side to the lower side in the plate thickness direction in a state where the body portion is deformed. With such a configuration, an area of a back surface of the washer which is brought into contact with the object to be fastened is increased and hence, a face pressure which the object to be fastened receives by fastening of the screw can be more dispersed whereby sinking of the object to be fastened can be prevented.

Further, in a situation where loosening of the fastened screw can be checked only from above the screw, when the screw is firmly fastened, the circumferential side surface can be visually recognized from above the screw, while when the screw is loosened, the circumferential side surface cannot be visually recognized. Accordingly, the inspection of loosening of the screw can be performed easily and with certainty regardless of a portion where the screw is fastened.

According to the invention described in claim 4, the corner portion of the lower bottom of the circumferential side surface is chamfered over an entire circumference. With such a configuration, when the shape of the washer changes from a dome shape to a plate shape at a time of fastening the screw, it is possible to prevent the occurrence of a damage on a surface of the object to be fastened.

According to the invention described in claim 5, the ornament is applied to the circumferential side surface. With such a configuration, for example, in a state where color is applied over the entire surface or the entire periphery, when the screw is firmly fastened, the color of the circumferential side surface can be visually recognized from above the screw, while when the screw is loosened, the color of the circumferential side surface cannot be visually recognized. Accordingly, the inspection of loosening of the screw can be performed more easily and with certainty regardless of a portion where the screw is fastened.

By applying color, a groove, a dot or the like which can be visually recognized to a portion of the circumferential side surface, not only it is possible to use the groove, a dot or the like perform in the above-mentioned inspection of loosening of the screw, but also it is also possible to make such the color, the groove, the dot or the like function as a marker used for determining the rotation of the washer caused by loosening of the screw.

### BRIEF DESCRIPTION OF THE DRAWINGS

FIG. 1 is a perspective view of a washer according to an embodiment;

FIG. 2A is a plan view of the washer according to the embodiment;

FIG. 2B is a bottom plan view of the washer;

FIG. 3A is a front perspective view of the washer according to the embodiment;

FIG. 3B is a cross-sectional view of the washer taken along a line A-A in FIG. 2A;

FIG. 3C is a left side perspective view of the washer;

FIG. 3D is a cross-sectional view of the washer taken along a line B-B in FIG. 2A;

FIG. 3E is a right side perspective view of the washer;

FIG. 3F is a cross-sectional view of the washer taken along a line C-C in FIG. 2A;

FIG. 4A is a partial cross-sectional view showing a state where the washer according to the embodiment is disposed between a bolt and a portion to be fastened before the screw is fastened;

FIG. 4B is a partial cross-sectional view of the washer showing a state after the screw is fastened;

FIG. 5A is a partial cross-sectional view of the washer according to the embodiment showing a state of the washer which is disposed between a nut and the portion to be fastened before the screw is fastened; and

FIG. 5B is a partial cross-sectional view showing a state of the washer after the screw is fastened.

### DETAILED DESCRIPTION OF PREFERRED EMBODIMENT

The gist of a washer according to the present invention lies in that the washer includes a body portion having a dome shape in an external appearance, wherein a screw insertion hole is formed in the body portion, and the body portion is formed of a spring member which is deformable into an approximately flat plate shape by a pressing force in a vertical direction, and is formed to be inclined toward one side in a state where the body portion is formed into a plate shape. That is, the present invention intends to provide the washer which aims at the realization of prevention of loosening of a screw at a high level by enhancing a frictional force between a male screw and a female screw hole or a nut while maintaining advantageous effects of a plain washer and a spring washer with a simple structure.

In this embodiment, a screw used with reference to the present invention is a general term of an object where projections in a spiral shape (a male screw) are formed on an outer surface of a circular cylindrical shape, a conical shape or the like. In this embodiment, the description is made using a hexagonal bolt having a screw head (hereinafter, referred to as “bolt”) as the screw. A nut is a general term of an object where projections in a spiral shape (a female screw) are formed on an inner surface of a circular cylindrical shape, a conical shape or the like. In this embodiment, the description is made using a hexagonal nut (hereinafter referred to as “nut”) having a female screw on an inner surface of a through hole as the nut.

In this embodiment, with respect to the direction of the dome-shaped washer, the description is made by setting a protruding direction as an upward direction. Further, unless otherwise particularly described as “plate shape”, the description is made with respect to the dome-shaped washer in principle.

Hereinafter, an embodiment of the washer according to the present invention is described with reference to drawings. In the description, with respect to structures and parts which are equal on left and right sides or are in a left and right symmetry, the structures and parts are given with the same symbols in principle, the structures and parts only on either the left side or the right side are described, and the description of the structures and parts on the other side is suitably omitted.

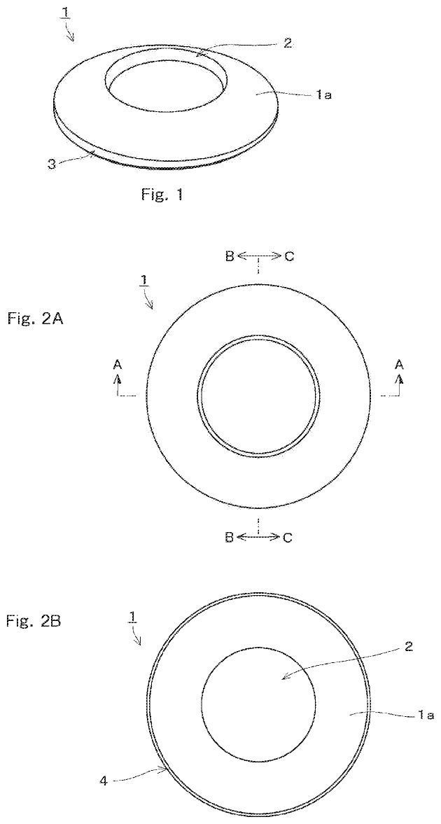

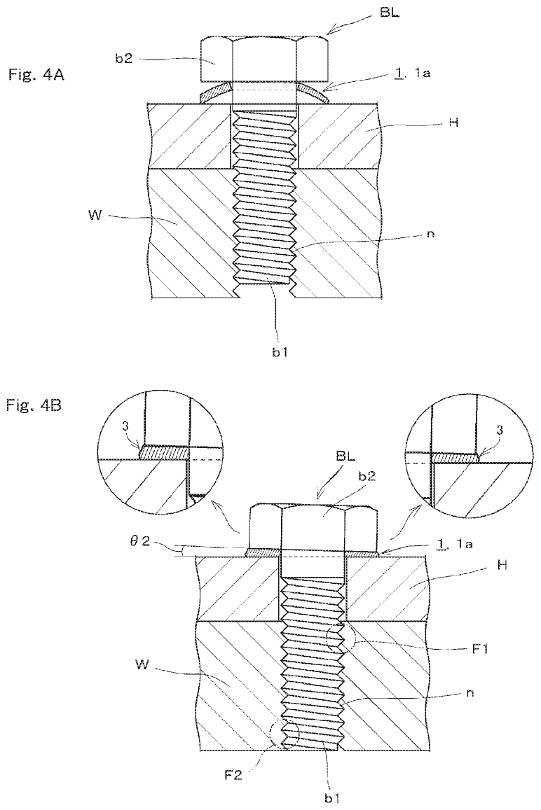

As shown in FIG. 1, FIG. 4A, and FIG. 4B, a washer 1 according to the embodiment of the present invention includes a body portion 1a having a dome shape in an external appearance. A screw insertion hole 2 is formed in the body portion 1a, and the body portion 1a is formed of a deformable spring member which is deformed into an approximately flat plate shape by a pressing force applied in a vertical direction. Further, the body portion 1a is formed so as to be inclined toward one side when the body portion 1a is deformed into a plate shape.

That is, with the use of the washer 1 according to the embodiment, as shown in FIG. 4A, in fastening an object to be fastened H to an object member W on which a female screw n is formed using a bolt BL, a male screw b1 of the bolt BL is inserted into the washer 1 in a state where a lower side of the washer 1 is indented, and the bolt BL is fastened to the object member W by way of the object to be fastened H. Accordingly, as shown in FIG. 4B, the washer 1 is pressed between a bolt head b2 and the object to be fastened H, and can be formed into a plate shape which is approximately flat and is inclined.

With respect to the washer 1 which is formed into a plate shape and is inclined, a biasing force which intends to move the bolt head b2 in an obliquely upward direction acts due to an elastic force of the washer 1 which intends to return to a dome shape as a spring member. That is, as shown in FIG. 4B, between the male screw b1 and the female screw n of the object member W in which the male screw b1 is threadedly inserted, particularly, as portions where a largest load is applied to the male screw b1 which intends to move in a right oblique upward direction by the biasing force, a frictional force at a stress concentration point F1 on a right upper side of the female screw n and a frictional force at a stress concentration point F2 on a left lower side of the female screw n are increased and hence, loosening of the bolt BL can be prevented so long as the biasing force continues.

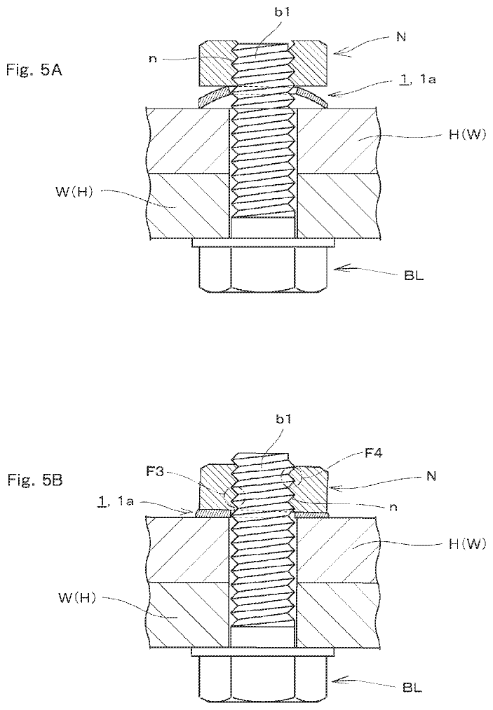

As shown in FIG. 5A and FIG. 5B, the washer 1 according to the embodiment of the present invention can be also used between a nut N and the object to be fastened H. In this case, in a female screw n formed in the nut N, stress concentration points F3, F4 are generated between the female screw n and a male screw b1 and hence, a frictional force is increased. Accordingly, loosening of the bolt BL can be prevented in the same manner.

Hereinafter, specific configuration of the respective portions is described in detail.

As a material of the body portion 1a which forms the washer 1 of the embodiment, an SK-85 material which is spring steel is used. However, for example, the material of the body portion 1a is not particularly limited in this embodiment provided that the body portion 1a is formed of a spring member such as SUS254SMO, SUS303, SUS304L, SUS316L or the like.

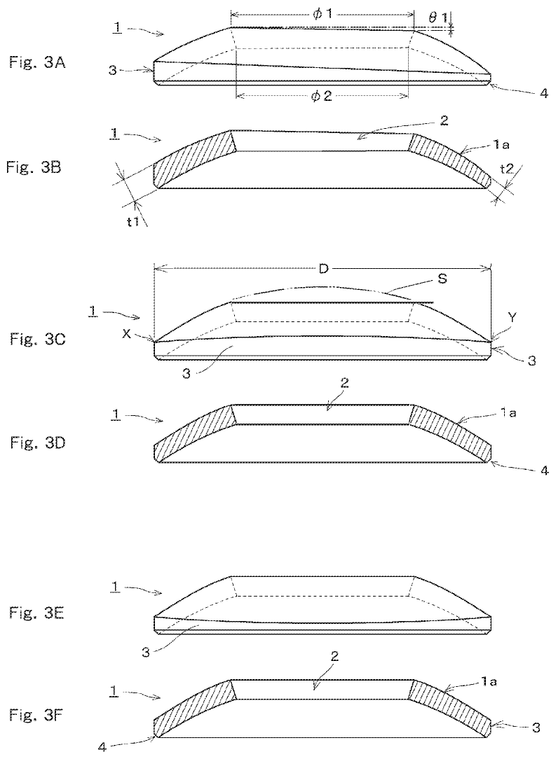

The washer 1 according to the embodiment having a dome shape in an external appearance is, as shown in FIG. 2A and FIG. 2B, formed into a donut shape as viewed in a plan view where the screw insertion hole 2 is formed in a center portion of the washer 1 in a vertical direction. As shown in FIG. 3C, a diameter D of the washer 1 is set to approximately 19 mm.

On a surface of the body portion 1a, a convex surface ranging from one outermost end X to the other outermost end Y in a radial direction is formed as a smooth curved surface. To add a trajectory (portion indicated by a broken line) S when it is assumed that the body portion 1a exists at a portion where the screw insertion hole 2 is formed, the convex surface is formed such that an imaginary length of an arc from one outermost end X to the other outermost end Y becomes approximately 20 mm. Further, a smooth curved surface having a curvature which approximates a curvature of a front surface side is formed also on a concave surface on a back surface side of the body portion 1a.

The diameter D and the imaginary length of the arc of the above-mentioned body portion 1a are not limited to the values described in the embodiment.

As can be clearly understood from a front perspective view shown in FIG. 3A, the body portion 1a is formed in a slightly inclined manner from a left side to a right side by an angle θ1 in an external appearance. Further, as can be also clearly understood from FIG. 3B which is a cross-sectional view taken along a line A-A in FIG. 2A which is a plan view, a plate thickness of the body portion 1a is set such that the plate thickness is gradually decreased from the left side to the right side. In this embodiment, a plate thickness t1 on a left end portion side is set to approximately 1.5 mm, and a plate thickness t2 on a right end portion side is set to approximately 1.0 mm. However, the plate thickness is not limited to the values described in the embodiment.

A change in the plate thickness appears as inclination when the body portion 1a having a dome shape is formed into an approximately flat plate shape (see FIG. 4B). In this embodiment, the body portion 1a is formed such that an inclination angle θ2 becomes approximately 1.5° when the body portion 1a is formed into a plate shape. However, the inclination angle θ2 is not limited to the value described in the embodiment.

With respect to an external appearance shown in FIG. 3C which is a left side surface perspective view and an external appearance shown in FIG. 3E which is a right side surface perspective view, the angle θ1 at which the body portion 1a is inclined from the left side to the right side as described above (FIG. 3A) is not formed. That is, the body portion 1a is formed horizontally and is formed symmetrically in a left-and-right direction.

In the washer 1 according to the embodiment, as described above (FIG. 3A), the washer 1 is formed in an inclined manner in an external appearance from the left side where the plate thickness is large to the right side where the plate thickness is small. However, the embodiment is not limited to such a configuration, and the body portion 1a may be formed with no inclination.

As shown in FIG. 3A, FIG. 4A and the like, the screw insertion hole 2 has an inner diameter which is narrowed from an upper side to a lower side in a plate thickness direction, and as shown in FIG. 4B, the screw insertion hole 2 is formed to have an approximately same inner diameter from the upper side to the lower side in the plate thickness direction when the washer 1 is deformed from a dome shape to a plate shape.

In this embodiment, as shown in FIG. 3A, the insertion hole 2 is formed such that, when the washer 1 is in a dome shape, an inner diameter ϕ1 of an upper side of the screw insertion hole 2 is set to approximately 10.9 mm, and an inner diameter ϕ2 of a lower side of the insertion hole 2 is set to approximately 10.2 mm, and when the washer 1 is formed into a plate shape, the inner diameter is set to approximately 10.8 mm. However, these sizes are not limited to the values described in the embodiment.

A circumferential side surface 3 of the body portion 1a is, as shown in FIG. 3A, FIG. 4A and the like, formed approximately vertically from the upper side to the lower side in a plate thickness direction, and as shown in FIG. 4B, when the washer 1 is deformed from a dome shape to a plate shape, the circumferential side surface 3 is formed so as to expand toward an outer side from the upper side to the lower side in a plate thickness direction.

Further, in the washer 1 according to the embodiment, as shown in FIG. 3A, FIG. 3D, FIG. 3F and the like, a corner portion 4 of a lower bottom of the circumferential side surface 3 is chamfered over the entire circumference. To be more specific, chamfering having a radius of 0.3 mm is applied to the entire circumference. The chamfering size is not limited to the value described in the embodiment. The presence or non-presence of chamfering is also not limited to the embodiment, and the circumferential side surface 3 may be formed with no chamfering.

An ornament may be also applied to the circumferential side surface 3. For example, color is applied to the entire surface or the entire circumference of the circumferential side surface 3 shown in FIG. 4B, or color, a groove, a dot or the like which can visually recognized can be formed on a portion of the circumferential side surface 3 or the like.

The washer according to the embodiment has the configuration described above. That is, the washer includes the body portion 1a having a dome shape in an external appearance. The screw insertion hole 2 is formed in the body portion 1a, the body portion 1a is formed of the spring member which is deformable into an approximately flat plate shape by a pressing force in a vertical direction, and is formed to be inclined toward one side when the washer 1 is deformed into a plate shape. With such a configuration, the washer 1 can exhibit an advantageous effect of a plain washer that sinking of an object to be fastened can be prevented by dispersing a face pressure which the object to be fastened receives and an advantageous effect of a spring washer that a frictional force in a vertical direction of the screw BL can be increased by fastening the screw BL thus preventing loosening of the screw can be obtained with a simple structure. Further, a direction of an axial force of the screw BL can be obliquely displaced. Accordingly, the washer 1 can realize the prevention of loosening of the screw BL at a high level.

The washer 1 has the simple structure and hence, the washer 1 can be manufactured at a low cost. Further, with the use of the spring member, the washer 1 can easily return from a plate shape to an original dome shape and hence, the washer can be repeatedly used.

The screw insertion hole 2 is formed to have an inner diameter which is narrowed from an upper side to a lower side in a plate thickness direction, and to have an approximately same inner diameter from the upper side to the lower side in the plate thickness direction in a state where the body portion 1a is deformed into the plate shape. With such a configuration, in inserting the male screw b1 toward the screw insertion hole 2 from above the body portion 1a, the narrowed inner diameter guides the male screw b1 and hence, an insertion operation can be easily performed. Particularly, when a large number of screws BL are to be fastened, operability can be largely enhanced.

The circumferential side surface 3 of the body portion 1a is formed approximately vertically from an upper side to a lower side in a plate thickness direction, and is formed to expand toward an outside from the upper side to the lower side in the plate thickness direction when the body portion 1a is deformed. With such a configuration, an area of a back surface of the body portion 1a which is brought into contact with the object to be fastened is increased and hence, a face pressure which the object to be fastened H receives by fastening of the screw BL can be more dispersed whereby sinking of the object to be fastened H can be prevented.

Further, in a situation where loosening of the fastened screw BL can be checked only from above the screw BL, when the screw BL is firmly fastened, the circumferential side surface 3 can be visually recognized from above the screw BL, while when the screw BL is loosened, the circumferential side surface 3 cannot be visually recognized. Accordingly, the inspection of loosening of the screw BL can be performed easily and with certainty regardless of a portion where the screw BL is fastened.

The corner portion 4 of the lower bottom of the circumferential side surface 3 is chamfered over an entire circumference. With such a configuration, when the shape of the washer 1 changes from a dome shape to a plate shape at a time of fastening the screw BL, it is possible to prevent the occurrence of a damage on a surface of the object to be fastened H.

An ornament is applied to the circumferential side surface 3. With such a configuration, for example, in a state where color is applied over the entire surface or the entire periphery, provided that the screw BL is firmly fastened, the color of the circumferential side surface 3 can be visually recognized from above the screw BL, while when the screw BL is loosened, the color of the circumferential side surface 3 cannot be visually recognized. Accordingly, the inspection of loosening of the screw BL can be performed more easily with certainty regardless of a portion of the fastened screw BL.

By applying color, a groove, a dot or the like which can be visually recognized to a portion of the circumferential side surface 3, it is possible to perform not only the above-mentioned inspection of loosening of the screw BL but also making such a color, a groove, a dot or the like function as a marker used for determining the rotation of the washer 1 caused by loosening of the screw BL.

Although the preferred embodiment of the washer according to the embodiment of the present invention has been described heretofore, the present invention is not limited to the specific embodiment, and various modifications and alterations are conceivable.

### REFERENCE SIGNS LIST

ϕ1: inner diameter on upper side

ϕ2: inner diameter on lower side

1: washer

1a: body portion

2: screw insertion hole

3: circumferential side surface

4: corner portion of lower bottom

1. A washer comprising a body portion having a dome shape in an external appearance, wherein
a screw insertion hole is formed in the body portion, and
the body portion is formed of a spring member which is deformable into an approximately flat plate shape by a pressing force in a vertical direction, and is formed to be inclined toward one side as a whole in a state where the body portion is deformed into a plate shape.

2. The washer according to claim 1, wherein the screw insertion hole is formed to have an inner diameter which is narrowed from an upper side to a lower side in a plate thickness direction, and to have an approximately same inner diameter from the upper side to the lower side in the plate thickness direction in a state where the body portion is deformed into the plate shape.

3. The washer according to claim 1, wherein a circumferential side surface of the body portion is formed approximately vertically from an upper side to a lower side in a plate thickness direction, and is formed so as to expand toward an outside from the upper side to the lower side in the plate thickness direction in a state where the body portion is deformed into a plate shape.

4. The washer according to claim 3, wherein a corner portion of a lower bottom of the circumferential side surface is chamfered over an entire circumference.

5. The washer according to claim 4, wherein an ornament is applied to the circumferential side surface.
